(19) United States
(12) Patent Application Publication
(10) Pub. No.: US 2007/0001963 A1
(43) Pub. Date: Jan. 4, 2007

(54) Liquid crystal display unit and driving method therefor and drive device for liquid crystal display panel

(75) Inventor: Norio Koma, Osaka (JP)

Correspondence Address: CANTOR COLBURN, LLP, 55 GRIFFIN ROAD SOUTH, BLOOMFIELD, CT, 06002, US

(73) Assignee: SANYO ELECTRIC CO., LTD., Osaka (JP)

(21) Appl. No.: 10/574,670

(22) PCT Filed: Oct. 4, 2004
(86) PCT No.: PCT/JP04/14618

§ 371 Date: Mar. 31, 2006

(30) Foreign Application Priority Data
Oct. 2, 2003 (JP) 2003-344999
Sep. 6, 2004 (JP) 2004-258566

(51) Int. Cl. G09G 3/36

(52) U.S. Cl. 345/96

(57) ABSTRACT

The polarity inversion cycle of a voltage applied to a liquid crystal layer is set to at least 2-frame cycle, or more preferably to as long as about 10 sec. Accordingly, a flicker that could not have been prevented at a polarity inversion cycle of about one frame can be prevented, and a longer inversion cycle can reduce power consumption. A material low in ion reactivity and small in residual polarization is used as a liquid crystal material or an orientation film material, thereby preventing the occurrence of a residual DC component in a liquid crystal layer and the deterioration of display quality despite a longer polarity inversion cycle. In the case of an LCD provided with a minimal transmittance with respect to an applied voltage, black can be accurately displayed by, for example, regulating a common electrode potential so that an applied voltage at which the transmittance of a liquid crystal shows a minimum value during an anodic application period is equal to that during a cathodic application period.

### TECHNICAL FIELD

The present invention relates to a liquid crystal display device, and, more particularly, to polarity inversion of a voltage to be applied to a liquid crystal layer.

### BACKGROUND ART

Liquid crystal display devices exhibiting small thickness and size and low power consumption are currently employed as display devices in various devices. A liquid crystal display device (hereinafter referred to as “LCD”) has a structure in which liquid crystal is sealed between two substrates, and electrodes are formed on the respective substrates so as to oppose each other. In the LCD, display is achieved by applying a voltage signal between the electrodes in order to control alignment of the liquid crystal in which optical characteristics change depending on the alignment state, to thereby control transmittance of light from a light source.

As is conventionally known, when a direct current voltage is continuously applied between the electrodes formed on opposing surfaces of the substrates, the alignment state of the liquid crystal molecules is fixed, which is a problem commonly called “image persistence.” Thus, conventionally, an alternating current voltage signal is used as the voltage signal for driving the liquid crystal in which a polarity with respect to a reference voltage is periodically inverted.

In a liquid crystal display device in which a plurality of pixels are arranged in a matrix form at each frame, polarity of the liquid crystal driving voltage signal is inverted at each vertical scan (1V) period (or 1 field period), at each horizontal scan (1H) period, and at each pixel (1 dot) period. One frame period is, for example, one frame period in an NTSC signal, and one field period corresponds to each period (for example, an odd field and an even field) of a plurality of fields forming one frame. However, LCDs often do not employ a method in which a horizontal scan line of an odd number and a horizontal scan line of an even number are driven at the odd field and even field, respectively, in one frame period (interlace drive) similar to a well-known display method of CRT display devices; rather, LCDs often employ a method in which all pixels (horizontal scan lines of odd and even numbers) are sequentially driven a plurality of times (for example, two times) (non-interlace drive) in one frame period. In this configuration, one field period (or one vertical scan period) corresponds to a period in which one frame period is divided by the number of times that all pixels are driven.

FIG. 12 shows a waveform of a drive voltage and a change in transmittance of the liquid crystal when a pixel of an LCD is driven while polarity inversion of the liquid crystal drive voltage for each field period is performed. As the LCD, an active matrix LCD in which each pixel comprises a thin film transistor (TFT) is employed. As shown in FIG. 12(a), in this structure, polarity inversion is performed, at each field period in each frame period, for a display voltage Vp applied to a pixel electrode which is connected to the TFT and which is formed in an individual pattern for each pixel with respect to a voltage signal (common voltage signal) Vcom applied to a common electrode which opposes each pixel electrode with the liquid crystal layer therebetween and which is formed common to all pixels.

In FIG. 12, a normally-white-type liquid crystal is used as the liquid crystal, and there is considered a configuration in which a black display is to be realized in each frame period in a target pixel.

Because the transmittance of liquid crystal layer in an LCD is determined by an absolute value of the voltage applied to the liquid crystal layer, when a black display is to be realized, the absolute value of a potential difference between the display voltage Vp and the common electrode potential Vcom desirably attains the same value in a field period of a positive polarity and in a field period of a negative polarity. However, as shown in FIG. 12 (a), the waveform of the display voltage Vp actually applied to the pixel electrode is not completely symmetrical in the positive polarity field period and the negative polarity field period. One reason for this is that a value indicated by ΔV in FIG. 12(a) differs between the positive polarity period and the negative polarity period.

ΔV is determined by the following equation (2):
ΔV=Vg*(Cg/(Clc+Csc+Cg)) (2)

FIG. 13 shows an equivalent circuit in each pixel of an active-matrix-type LCD. Referring to FIG. 13, the term Vg in the above-described equation (2) is a scan signal voltage (gate signal voltage) to be applied to a gate electrode for selecting a TFT in each pixel, Cg is a gate parasitic capacitance between a gate electrode and a source region of the TFT, Clc is capacitance of a liquid crystal, and Csc is capacitance of a storage capacitor which is connected in parallel to the liquid crystal capacitance and stores a display signal until a pixel is next selected and a display signal is written.

The polarity of the gate signal electrode for switching the TFT provided in each pixel as a switching element ON is the same (here, positive polarity) in the positive polarity field period and the negative polarity field period. Thus, the sign of ΔV is equal in the positive polarity field period in which a gate signal voltage Vg is applied and a display voltage Vp of positive polarity is written to the pixel electrode and in the negative polarity field period in which a gate signal voltage Vg is applied and a display voltage Vp of negative polarity is written to the pixel electrode. In addition, the value of Clc changes in response to a voltage applied to the liquid crystal layer, and the value of ΔV changes accordingly. Therefore, a difference tends to arise in the effective voltage which is applied to the liquid crystal between the positive polarity field period and the negative polarity field period. The difference in effective voltage becomes a change of transmittance of the liquid crystal with respect to time, and, when the temporal shift periodically occurs in a period of one frame, a display flicker is observed by a viewer.

Moreover, in the transition period between the positive polarity period and the negative polarity period, waveform rounding occurs in correspondence to a time constant determined primarily by the liquid crystal capacitance Clc and the storage capacitance Csc in the waveform of the voltage actually applied to the liquid crystal because of a change in potential of the display voltage Vp. Furthermore, because the alignment state of the liquid crystal changes according to a change in the actually applied voltage following the change at a response rate which is intrinsic to liquid crystal, some time is required between application of the voltage and the actual change of transmittance of liquid crystal. Because of this, a change of transmittance in response to the periodic polarity inversion tends to occur at a slow rate.

For these reasons, when a method of inverting the polarity in each field is employed, as shown in FIG. 12(b), the alignment state of the liquid crystal molecules; that is, the transmittance, significantly changes following the transition between the positive polarity field period and the negative polarity field period. Because of characteristics of the human eye, the flickers tend to be more visible when the drive frequency is approximately 50 Hz or less. Therefore, flickering occurs when the change in transmittance occurs at a frequency less than or equal to 50 Hz. In order to reduce flickering, therefore, it has been necessary to reduce the time period of change in the transmittance of LCD, by means of applying a vertical scan line (V line) inversion as shown in FIG. 14(b), a horizontal scan line (H line) inversion as shown in FIG. 14(c), a dot inversion as shown in FIG. 14(d), etc., in addition to the polarity inversion for each field as shown in FIG. 14(a).

Meanwhile, strong demands exist for further reduction in power consumption in various devices equipped with the LCDs, and further reduction in power consumption is necessary for the LCD. In a method considered effective for achieving this, the drive frequency in the LCD employing the AC driving method is reduced. However, as described above, in LCDs, highest priority has been placed on inhibition of the flickering due to response speed of the liquid crystal, asymmetry of the waveform of the drive voltage, and occurrence of residual DC voltage, in order to maintain display quality in a normal display mode. In addition, in the polarity inversion of field period, as described above, a transmittance change at a frequency of approximately 30 Hz corresponding to the frame frequency arises, and flickering is often observed. Therefore, in a normal display mode that requires high display quality, no attempt has been made to reduce the frequency of polarity inversion.

In addition, in conventional LCDs, when a display voltage Vp having the same polarity is applied for two field periods or longer, the residual DC (direct current voltage) component applied to the liquid crystal layer becomes significantly large and, even when a display voltage Vp corresponding to the display content to be applied to the liquid crystal is applied to the pixel electrode, the voltage applied to the liquid crystal is changed by the residual DC voltage, resulting in problems that display cannot be appropriately realized and that the residual DC voltage increases flickering.

### DISCLOSURE OF INVENTION

According to the present invention, there is provided a liquid crystal display device (LCD) in which two substrates having respective electrodes for driving liquid crystal on opposing surfaces are provided opposing each other with a liquid crystal layer therebetween and comprising a plurality of pixels or a driving method thereof, wherein a liquid crystal drive voltage applied to the liquid crystal layer in each pixel is maintained at the same polarity with respect to a predetermined reference for a period of two frame periods or longer.

According to another aspect of the present invention, the LCD or driving method thereof comprises a liquid crystal drive signal processor which generates a liquid crystal drive voltage to be applied to the liquid crystal layer on the basis of an image signal, and a predetermined period determination unit which determines elapse of a predetermined period which is two frame periods or longer and outputs a polarity inversion control signal for inverting a polarity of the liquid crystal drive voltage, wherein the liquid crystal signal processor inverts the polarity of the liquid crystal drive voltage according to the polarity inversion control signal and maintains the liquid crystal drive voltage applied to the liquid crystal layer in each pixel at the same polarity with respect to a predetermined reference for a period of two frame periods or longer.

According to another aspect of the present invention, the liquid crystal drive voltage is maintained at the same polarity for a period of 10 seconds or longer.

According to another aspect of the present invention, the LCD further comprises a setter unit which arbitrarily sets the determination period in the predetermined period determination unit.

According to another aspect of the present invention, a minimum unit of the polarity inversion of the liquid crystal drive voltage is one screen drive period corresponding to a drive period of all pixels of the plurality of pixels.

According to another aspect of the present invention, in the LCD, when a maximum application voltage Vpmax which is applied to the liquid crystal layer is applied to the liquid crystal layer at the same polarity for a period t, a residual direct current voltage Vdc generated in the liquid crystal layer satisfies the following equation (1):
Vdc≦0.1*Vpmax (1)

According to another aspect of the present invention, an application period for the liquid crystal drive voltage to be applied to the liquid crystal layer having a positive polarity and an application period for the liquid crystal drive voltage to be applied to the liquid crystal layer having a negative polarity are equal to each other.

According to another aspect of the present invention, the LCD has a characteristic in which a transmittance with respect to an application voltage has a minimum value.

According to another aspect of the present invention, the LCD operates in an electrically controlled birefringence mode.

According to another aspect of the present invention, the LCD has a characteristic in which transmittance with respect to an application voltage has a minimum value, and an electrode potential on an opposing substrate is set such that an absolute value of a potential difference is equal during a period in which the liquid crystal drive potential applied to the liquid crystal layer is of a positive polarity with respect to the electrode potential on the opposing substrate and a period in which the liquid crystal drive potential is of a negative polarity with respect to the electrode potential on the opposing substrate during black display.

According to another aspect of the present invention, in the LCD, a polarity of a voltage applied to a pixel electrode formed individually for each of the plurality of pixels with respect to a predetermined reference is inverted at the period of two frame periods or longer and a voltage applied to a common electrode which opposes the pixel electrode with the liquid crystal layer therebetween is set to a constant, so that a polarity of a liquid crystal drive voltage applied to the liquid crystal layer with respect to a predetermined reference is inverted and driven at the period of two frame periods or longer.

According to another aspect of the present invention, in the LCD, a polarity of a voltage applied to a pixel electrode formed individually for each of the plurality of pixels with respect to a predetermined reference is inverted at the period of two frame periods or longer and a polarity of a voltage applied to a common electrode which opposes the pixel electrode with the liquid crystal layer therebetween is inverted in synchronization with the inversion of the polarity of the voltage applied to the pixel electrode.

According to another aspect of the present invention, the LCD comprises an opposing electrode driver which drives the electrode on the opposing substrate and the opposing electrode driver sets an electrode potential of the opposing substrate such that an absolute value of a potential difference is equal in a period in which a polarity of liquid crystal drive potential applied to the liquid crystal layer with respect to the electrode potential of the opposing substrate is a positive polarity and in a period in which the polarity of the liquid crystal drive potential applied to the liquid crystal layer with respect to the electrode potential of the opposing substrate is a negative polarity during black display.

According to another aspect of the present invention, there can be provided an adjustor unit which adjusts an electrode potential of the opposing substrate which is set by the opposing electrode driver.

According to another aspect of the present invention, a drive method of the LCD is realized through operations of a liquid crystal drive voltage processor and a predetermined period determination unit, software, etc.

According to another aspect of the present invention, there is provided a driver device which drives the LCD. The driver device is formed as one or a plurality of external IC chips.

According to the present invention, power consumption can be reduced while preventing occurrence of flickering in an LCD.

### BRIEF DESCRIPTION OF THE DRAWINGS

FIG. 1 is a drawing showing a waveform of polarity inversion of a voltage applied to liquid crystal and transmittance according to a preferred embodiment of the present invention.

FIG. 2 is a diagram schematically showing a system structure of an active matrix LCD 1 according to a preferred embodiment of the present invention.

FIG. 3 is a diagram schematically showing a circuit structure of a timing controller 130 according to a preferred embodiment of the present invention.

FIG. 4 is a diagram for explaining a relationship between a polarity inversion period and an animated image display characteristic.

FIG. 5 is a diagram showing an evaluation result of how the flickering is observed with respect to the polarity inversion period in a preferred embodiment of the present invention.

FIG. 6 is a diagram showing a characteristic of transmittance with respect to the voltage applied to the liquid crystal according to a preferred embodiment of the present invention.

FIG. 7 is a diagram showing a waveform of polarity inversion of the voltage applied to the liquid crystal and transmittance according to another preferred embodiment of the present invention.

FIG. 8 is a diagram schematically showing a circuit structure of an active matrix LCD 2 according to another preferred embodiment of the present invention.

FIG. 9 is a diagram schematically showing a circuit structure of a common electrode driver 141 according to another preferred embodiment of the present invention.

FIG. 10 is a cross sectional diagram for conceptually describing an operation of an rubbing-less type VA mode LCD.

FIG. 11 is a diagram showing other example patterns of an orientation divider of FIG. 10(c).

FIG. 12 is a diagram showing a waveform of polarity inversion of the application voltage to the liquid crystal and transmittance in the conventional art.

FIG. 13 is a diagram showing an equivalent circuit in a pixel of an active matrix LCD.

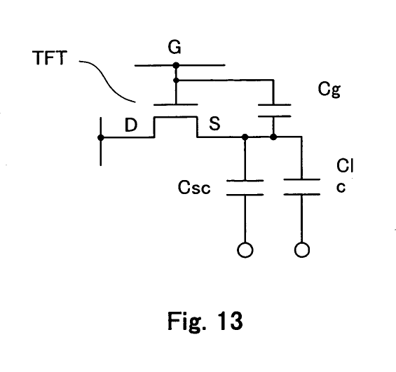

FIG. 14 is a diagram conceptually showing polarity inversion timing for field inversion, line inversion, and dot inversion.

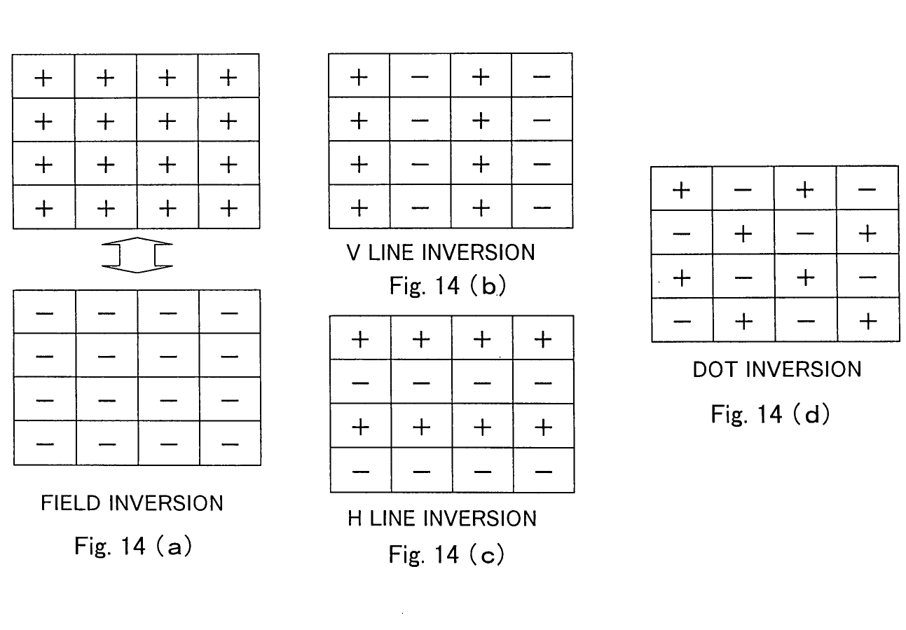

### BEST MODE FOR CARRYING OUT THE INVENTION

Preferred embodiments (hereinafter simply referred to as “embodiments”) of the present invention will now be described by reference to the drawings.

In an LCD according to the present embodiment, an inversion period of polarity of a liquid crystal drive voltage with respect to a reference value is set to a period of two frame periods or longer. In the LCD of the present embodiment, all pixels forming one screen are set at the same polarity and the polarity is inverted for each screen, and line inversion and dot inversion, in which the polarities of pixels on one screen differ for each line or each pixel, are not executed. In addition, the polarity inversion drive is not limited to an active matrix LCD having a switch such as a TFT in each pixel and may be applied to a passive matrix LCD or the like having no switch. However, in the following description, the present embodiment will be described by reference to an active matrix LCD intrinsically having a high display quality; in particular, a high display quality of animated images as compared with the other configurations.

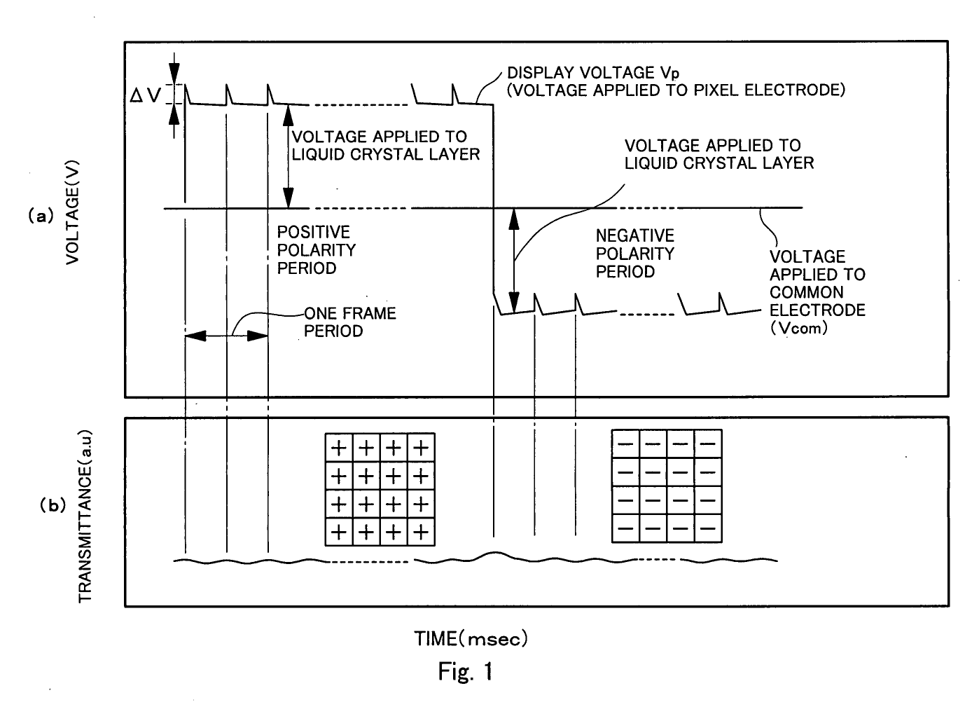

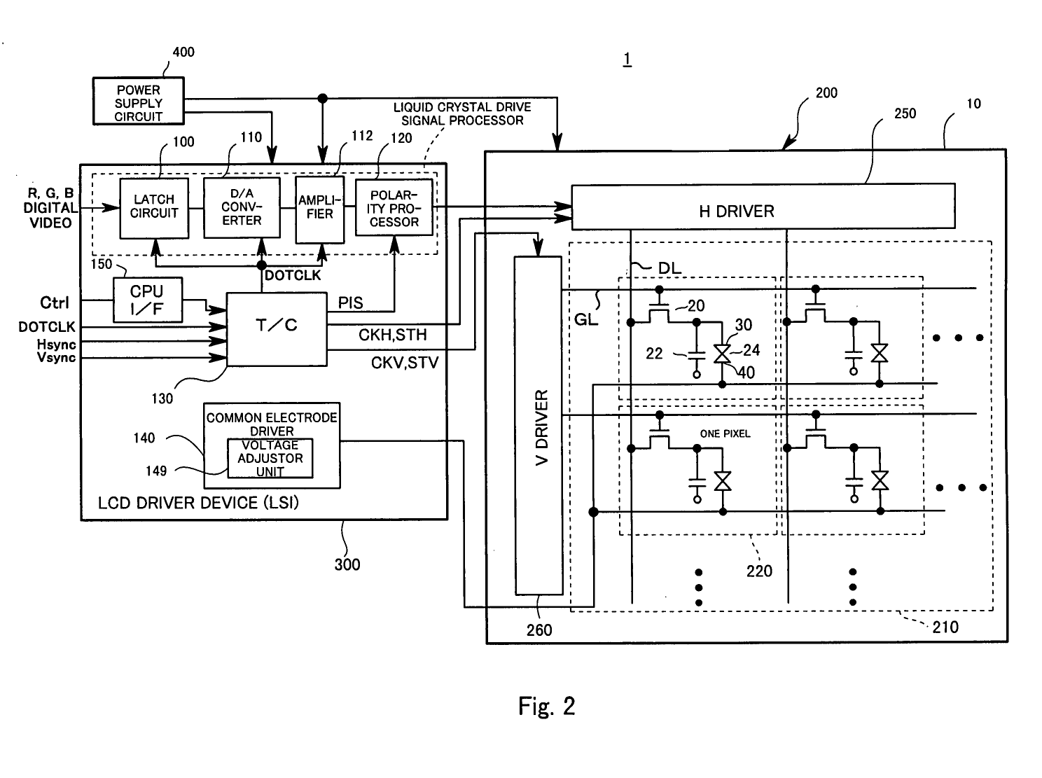

FIG. 1 shows a waveform of a drive voltage which is applied to a liquid crystal layer of a target pixel of an active matrix LCD according to the present embodiment and a change in transmittance of the LCD. FIG. 2 shows an example system structure of the LCD 1. The LCD 1 comprises an LCD panel 200 which is formed by affixing two substrates with a liquid crystal layer therebetween, and an LCD driver device (driver LSI) 300 which generates a drive signal, a timing signal, etc., which are necessary for operations of the LCD panel 200, and supplies the generated signal to the panel 200.

In the LCD panel 200, a plurality of pixels 220 are arranged in a matrix form within a display region 210. As shown in FIG. 2, each pixel 220 comprises a TFT 20, a storage capacitor 22, and a liquid crystal capacitance 24. In the present embodiment, a polarity of a display voltage Vp applied to a pixel electrode 30 connected to the TFT 20 and formed individually for each pixel with respect to a voltage signal (common electrode potential) Vcom which is applied to a side of an opposing electrode 40 (in the exemplified configuration, common electrode) opposing the pixel electrode 30 with the liquid crystal layer therebetween is periodically inverted as shown in FIG. 1(a). The polarity inversion period of the display voltage Vp is set to two frame periods or longer, more preferably, to a period longer than two frame periods, such as 10 seconds. Use of such a polarity inversion period in, for example, a normal display mode, enables realization of high display quality.

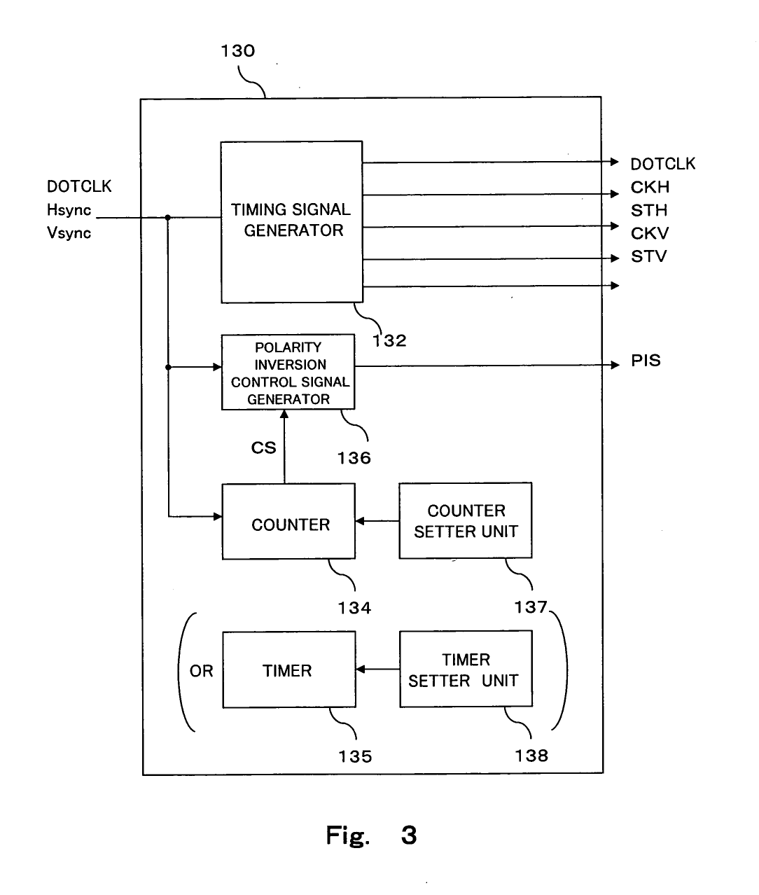

A structure for realizing driving in which the polarity inversion period is set to two frame periods or longer as described above will now be described by reference to FIGS. 2 and 3. As described, the LCD 1 comprises the LCD panel 200 in which liquid crystal is sealed between a pair of substrates and which has the display portion 210 in which a plurality of pixels 220 each having a low temperature polycrystalline silicon (LTPS) TFT used as a switching element are arranged in a matrix form, and the LCD driver device 300 which generates a drive signal, a timing signal, etc., which are necessary for operations of the LCD panel 200, and supplies the generated signals to the LCD panel 200. Power required by the LCD panel 200 and the LCD driver device 300 is supplied from a power supply circuit 400.

In the present embodiment, a horizontal (H) driver 250 and a vertical (V) driver 260 for driving each pixel circuit are formed on a substrate of the LCD panel on which the pixel TFT is formed. The H driver 250 and the V driver 260 are provided at a peripheral portion of the display portion 210, and an LTPS TFT which is formed through approximately the same steps as the pixel TFT is used in the H driver 250 and the V driver 260.

The LCD driver device 300 can be integrated as an LCD controller (LCD driver) LSI or the like. FIG. 2 shows a configuration in which digital R, G, B video signals are input from the outside; that is, a digital controller LSI. The LCD driver device 300 comprises, as a liquid crystal drive signal processor, a latch circuit 100 which latches R, G, and B digital video data (for example, 8 bits) which are supplied; a digital to analog (D/A) converter circuit 110; an amplifier unit 112; and a polarity processor 120. The LCD driver device 300 further comprises a CPU interface (I/F) 150 and a timing controller circuit (T/C) 130. The LCD driver device 300 further comprises a common electrode driver 140. The structure of the LCD driver device 300 is not limited to a structure in which all of these circuits are integrated on one chip. For example, the common electrode driver 140, etc. may be formed using a separate IC, or the power supply circuit 400 or the like may be built into the driver device. Alternatively, the driver device 300 may have a structure in which a plurality of displays in a portable phone (main display and sub display) can be driven with a single chip or may be formed as a portion of another signal processor circuit (for example, an image signal processor LSI which performs processes to demodulate an NTSC video signal from a received signal or from a replayed signal and to separate a synchronization signal).

In FIG. 2, the peripheral circuits such as the H driver 250 and the V driver 260 are built into the LCD panel 200. When, for example, an a-Si is used in the pixel TFT (structure known as an “a-Si TFT LCD”) or the H driver and V driver are formed into an IC chip in response to a demand for higher or more precise processes, these drivers may be incorporated in the driver device 300. Alternatively, the drivers 250, 260, or the like can be formed as one or a plurality of external driver devices (IC chips). In this case, the external IC chip may be formed on a glass substrate 10 through a COG (Chip On Glass) method or a TAB (Tape Automated Bonding) method. In addition, when a polycrystalline silicon TFT is used for the pixel TFT as in the present embodiment, all of the circuits shown in the driver device 300 in FIG. 2 may be built on the substrate 10 (“system on glass”).

A more specific structure and an operation of the LCD driver device 300 will now be described. First, the CPU I/F 150 receives a control signal (Ctrl) from a CPU (not shown) and outputs a control signal corresponding to the content of the control signal to the timing controller circuit 130, etc.

In the present embodiment, the timing controller circuit 130 has a function as a predetermined period determination unit for polarity inversion. In this configuration, the timing controller circuit 130 has a structure as shown in FIG. 3 and generates timing signals and control signals (CKH, STH, CKV, STV, etc.) which are necessary for operations and display of the latch circuit 100, D/A converter circuit 110, polarity processor 120, and H driver 250 and V driver 260 of the LCD panel 200, on the basis of a dot clock signal DOTCLK, a horizontal synchronization signal Hsync, and a vertical synchronization signal Vsync which are separately supplied and which will be described in detail later.

The latch circuit 100 latches R, G, and B digital video data (for example, 8 bits) which are supplied on the basis of, for example, the dot clock signal DOTCLK, which is directly supplied or supplied from the timing controller circuit 130.

The D/A converter circuit 110 converts the latch data from the latch circuit 100 to analog data, which are subsequently amplified by the amplifier unit 112 to a necessary amplitude (in some cases, the voltage level is shifted). In addition, a gamma correction or the like corresponding to the characteristic of the LCD is applied in the amplifier unit.

The R, G, and B analog data output from the amplifier unit 112 are then supplied to the polarity processor 120, and the polarity processor 120 inverts polarity of the R, G, and B analog data on the basis of a polarity inversion signal PIS supplied from the timing controller circuit 130. In this manner, analog data in which the polarity is inverted in a period of at least two frame periods or longer are output to the H driver 250.

FIG. 3 schematically shows a circuit structure of the timing controller 130. As shown in FIG. 3, the timing controller 130 comprises a timing signal generator 132 which generates various timing signals, a counter 134, and a polarity inversion control signal generator 136.

The timing signal generator 132 generates, for example, a horizontal clock signal CKH and a horizontal start signal STH on the basis of the dot clock signal DOTCLK, a horizontal synchronization signal Hsync, etc., and generates a vertical clock signal CKV and a vertical start signal STV on the basis of the dot clock signal DOTCLK, a vertical synchronization signal Vsync, etc. Although not shown, the timing signal generator 132 also generates an enable signal or the like for controlling prohibition and allowance of an output of a scan signal to a gate line (GL) in the LCD panel 200 on the basis of the dot clock signal DOTCLK, the horizontal synchronization signal Hsync, the vertical synchronization signal Vsync, etc.

The counter 134 counts the vertical synchronization signal Vsync which is provided once in every field, and outputs a control signal CS to the polarity inversion control signal generator 136 every time the count reaches a predetermined count number. As the predetermined count number, there can be used, for example, 4 counts (2 frames (in a case where 1 frame=2 fields)) of the vertical synchronization signal Vsync or 600 counts (10 seconds (frame frequency is approximately 30 Hz (in a case where 1 frame=2 fields))). In addition, it is also possible to additionally provide a counter setter unit 137 which sets the predetermined count value of the counter 134 as shown in FIG. 3 (alternatively, the setter unit 137 may be built in the counter 134). It is also possible to employ a configuration in which the count value set by the counter setter unit 137 is automatically adjusted on the basis of a detection result from a detector (not shown) which detects a residual direct current voltage Vdc generated in a liquid crystal layer when a maximum application voltage Vpmax to be applied to the liquid crystal layer is applied to the liquid crystal layer at the same polarity for a period t so that a relationship between the maximum application voltage Vpmax and the residual direct current voltage Vdc satisfies the following equation (1):
Vdc≦0.1*Vpmax (1)

This adjustment can be realized by, for example, a method in which an optimum period t for satisfying the above-described equation (1) in an expected drive environment (ambient temperature, drive voltage, etc.) is set in ROM, RAM, etc. in the form of a condition table, the temperature or the like is measured when the LCD is driven, and the period t is changed on the basis of the measurement result.

The polarity inversion control signal generator 136 outputs a polarity inversion control signal PIS to the polarity processor 120 on the basis of the control signal CS. The counter 134 may be formed from a timer 135. In this case, the timer 135 outputs the control signal CS to the polarity inversion control signal generator 136 once every predetermined period (for example, once every 10 seconds). Alternatively, there may be provided a timer setter unit 138 for setting a value of the predetermined time of the timer 135. When the timer 135 is employed, upon receipt of the control signal CS from the timer 135, the polarity inversion control signal generator 136 outputs the polarity inversion control signal PIS in synchronization with the vertical synchronization signal Vsync.

The polarity inversion control signal PIS obtained in this manner is output from the timing controller circuit 130 to the polarity processor 120. The polarity processor 120 inverts the polarity of the analog data on the basis of the polarity inversion control signal PIS as described above, and the obtained data are output to the H driver 250 so that the obtained data are supplied, as the display voltage Vp, to each data line DL of the LCD panel 200.

The common electrode driver 140 of the driver device 300 generates a common electrode potential Vcom to be supplied to the common electrode. For example, a power supply voltage supplied from the power supply circuit 400 is shifted to a suitable potential, and the shifted potential is output as the common electrode potential Vcom. The level of the common electrode potential Vcom is set by an adjustor unit 149 in consideration of the display voltage Vp, the liquid crystal characteristics, etc., so that the potential difference is equal with respect to the positive polarity level and the negative polarity level of the display voltage Vp which shows black display in a normally white mode. In other words, the adjustor unit 149 sets the potential of Vcom so that the potential difference becomes equal in the positive polarity period and the negative polarity period of the voltage applied to the liquid crystal during black display. It is also possible to employ a configuration in which, in the setting process, the potential of Vcom is automatically adjusted so that the potential difference becomes equal in the positive polarity period and the negative polarity period, on the basis of a detection result from a detector (not shown) which detects a voltage applied to the liquid crystal during black display. For example, an optimum Vcom for an expected drive environment is measured in advance as described above; the measured values are set in ROM or the like as a condition table; and an amount of level shift is changed in consideration of the drive environment so that an optimum Vcom is selected.

In the above description, there is exemplified a configuration in which the input video signal is a digital signal and a digital driver device 300 is used, but when the input video signal is an analog signal, an analog driver device 300 is used. In this case also, the timing controller 130 periodically generates a necessary timing signal and a polarity inversion control signal PIS at a predetermined period from the supplied synchronization signal, the polarity processor is built in the driver device 300, polarity of R, G, B analog video data to which γ correction or the like is applied is inverted, and the data are supplied to the H driver 250.

In both a case in which the video input is analog and a case in which the video input is digital, when the γ correction, polarity inversion, etc. with respect to the video data are to be digitally processed in the LCD driver device 300, these processes are applied to the digital video data as is, and a digital-to-analog (D/A) converter is provided on a route until a final output as a data signal Vp to each data line DL of the LCD panel 200. For example, the D/A converter can be formed between the H driver 250 and the display region 210 (the D/A converter is built on the substrate 10).

Next, driving of the LCD panel will be explained by reference to a normally white mode liquid crystal which displays white when no voltage is applied (off state). In a certain target pixel which maintains a black display in a normal display state, a display signal shown by Vp in FIG. 1(a) is applied to the pixel electrode 30 of the pixel at least every frame period.

As described, the horizontal clock signal CKH and the horizontal start signal STH are output from the timing controller circuit 130 to the H driver 250. The H driver 250 comprises a shift register of a plurality of steps and sequentially transfers the horizontal start signal STH while using the horizontal clock signal CKH as a clock signal. A sampling signal corresponding to the horizontal start signal STH transferred from every step of registers is output and, on the basis of the sampling signal, the sampling circuit sequentially captures display data signal (Vp) output from the driver device 300, and the display data signal (Vp) is output to the corresponding data line DL.

The vertical clock signal CKV and the vertical start signal STV are output from the timing controller circuit 130 to the V driver 260. Similar to the H driver 250, the V driver 260 comprises a shift register of a plurality of steps and sequentially transfers the vertical start signal STV while using the vertical clock signal CKV as a clock signal. A scan signal corresponding to the vertical start signal STV transferred from each step of the register is output for each horizontal scan line (gate line) GL.

When a scan signal is output, a TFT 20 of the pixel 220 having a gate electrode connected to the gate line is switched on, and a potential on the pixel electrode 30 connected to the source of the TFT 20 and one electrode of the storage capacitor 22 are set to a potential on the data line connected to the drain of the TFT 20; that is, a potential corresponding to a potential of the display data signal which is being output to the data line DL at that point. The waveform of the display voltage Vp shown in FIG. 1(a) is a voltage waveform which is actually applied to each pixel electrode 30 from the data line DL through the TFT 20.

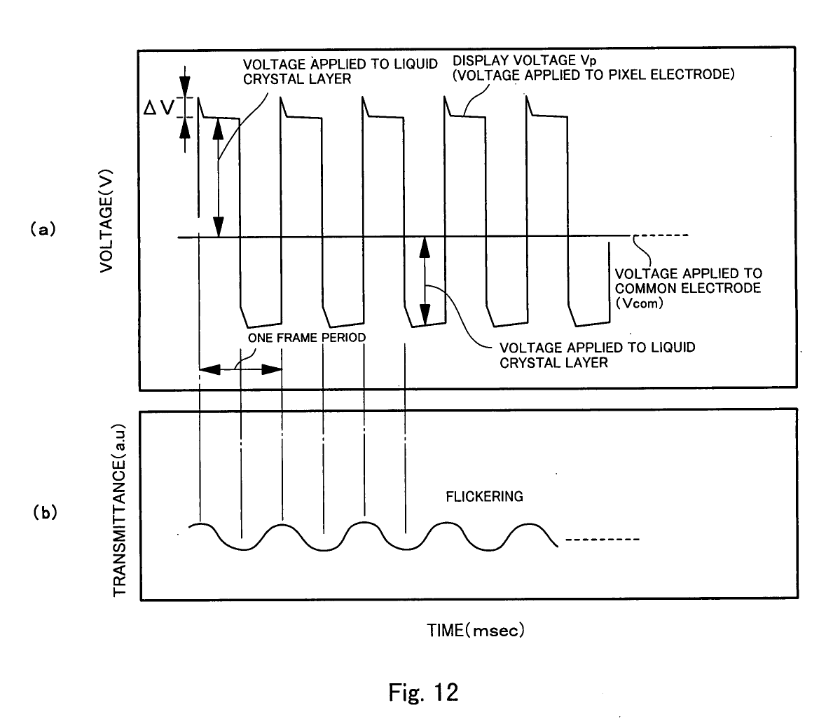

With the operations of the V driver 260 as described above, a scan signal having a high (H) level is output to the corresponding gate line GL at least once every vertical scan period (one field) and a display data signal is newly written through the TFT 20 to each pixel electrode 30. Therefore, during the writing operation, a voltage change ΔV indicated by the above-described equation (2) occurs in the display voltage Vp applied to the pixel electrode 30. The generation of such a voltage change ΔV in the display voltage Vp is similar to that in the device in the conventional art. However, in the present embodiment, because the polarity of the display voltage Vp with respect to the opposing electrode potential Vcom is maintained at the same polarity over a plurality of frame periods, there is almost no change in voltage which is actually applied to the liquid crystal layer during a period in which the display voltage Vp of the same polarity is applied. Therefore, as shown in FIG. 1(b), the change in transmittance of the LCD during the period in which the polarity of the display voltage Vp is the same is very small, as is clear from comparison with FIG. 12(b), and flickering does not occur. Although a change in transmittance of a period of one frame (that is, flickering) occurs when the polarity is inverted every field as shown in FIG. 12(b), the period of a small change in transmittance of the LCD in the present embodiment is one field, and, thus, the changing period of the transmittance is reduced by a factor of ½ and appearance of flickering can be prevented. In this manner, in the present embodiment, because flickering does not occur, contrast reduction due to occurrence of flickering can be prevented.

The display voltage Vp is maintained at the same polarity over a plurality of frame periods; for example, 10 seconds (positive polarity period in FIG. 1), and then the level is inverted to a level having the same absolute value of potential difference but the opposite polarity with respect to the common electrode potential Vcom (negative polarity period). In order to set the effective application voltage to the liquid crystal in each polarity period equal to each other, preferably, the positive polarity period and the negative polarity period are of the same length, and alternating current signals having the same absolute value and different signs with respect to Vcom in the polarity periods are used as the display signal (display voltage Vp). In the configuration exemplified in FIG. 1, the level of Vcom is set so that the potential differences with respect to the positive polarity level and the negative polarity level of the display voltage Vp showing a black display in a normally white mode are equal. In other words, the potential of Vcom is set so that the voltage applied to the liquid crystal has an equal potential difference during the positive polarity period and the negative polarity period when black is displayed.

As shown in FIG. 1(b), the transmittance of the LCD changes following a rapid and significant change of the effective voltage applied to the liquid crystal layer during transition from the positive polarity period to the negative polarity period. However, after the polarity is inverted once, the inverted polarity continues for a plurality of frame periods which are the same as in the non-inverted polarity period (for example, approximately 300 frame periods). Therefore, the change in transmittance in the transition period is not observed as flickering. In this manner, in the present embodiment, flickering can be prevented by means of setting the period of polarity inversion to a long period of multiple frame periods or longer.

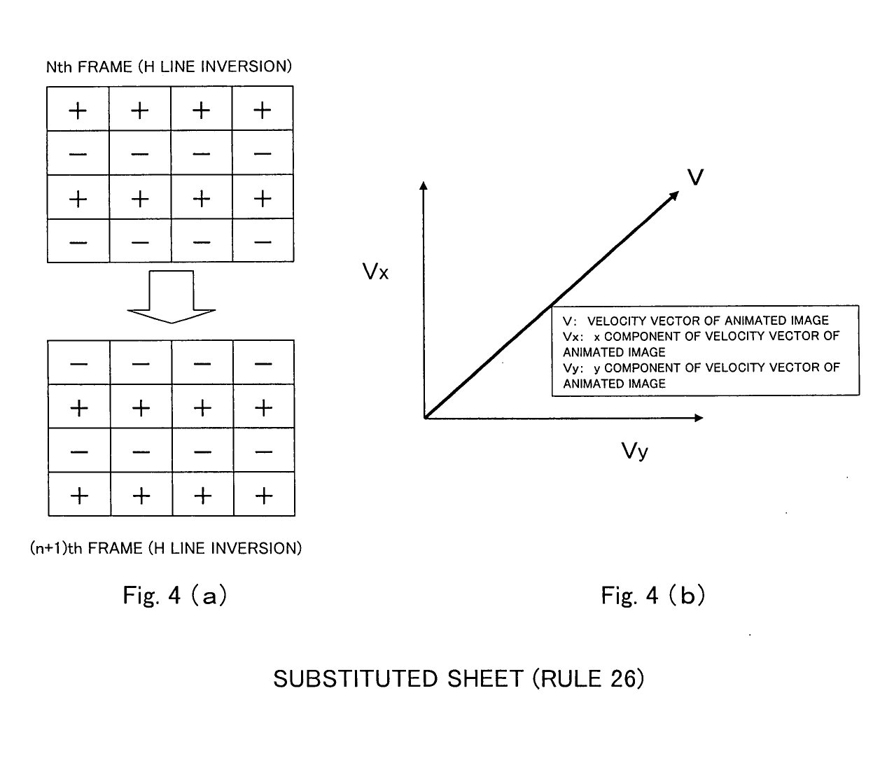

As described above, in the conventional method of H line inversion, the absolute value of the voltage applied to the liquid crystal layer differs between the positive polarity and the negative polarity. In such a case, when a still image is viewed, even though the absolute value of the voltage differs, the brightness change for each line is hardly recognized, because of averaging of brightness of adjacent pixels due to limited temporal and spatial resolution of the human eye. However, when an animated image is viewed, the eyes accurately follow the movement of the animated image by a tracing eye movement of the eyes. The degree of this movement will now be described referring to FIG. 4. The horizontal line of the positive polarity and the horizontal line of the negative polarity are imaged at the same position on the retina of an eye and brightness change for each horizontal line is viewed when an x component Vx of a velocity vector V of the animated image reaches a value of the following equation (3):
N*P/t (3)

In equation (3), n represents a positive integer, P represents a pixel pitch along a vertical direction, and t represents time of one frame. With a similar principle, when Vy in V line inversion attains the value of the above-described equation (3), brightness change for each vertical line is viewed. In V line inversion, the term P in the above-described equation (3) becomes a pixel pitch in the horizontal direction. In a dot inversion method also, the display characteristic of an animated image is reduced due to a principle similar to those in effect in the H line inversion and V line inversion. As described, in a polarity inversion method such as H line inversion, V line inversion, and dot inversion, when an animated image is displayed, movement of the image and the period of the line or dot inversion synchronize with each other and the animated image is degraded. In contrast, in the present embodiment, line inversion and dot inversion are not performed, the polarity is inverted at a period of two frame periods or longer, and the display data of all pixels are of the same polarity when viewed in one frame period. Therefore, the animated image is not degraded, and superior animation characteristic can be obtained.

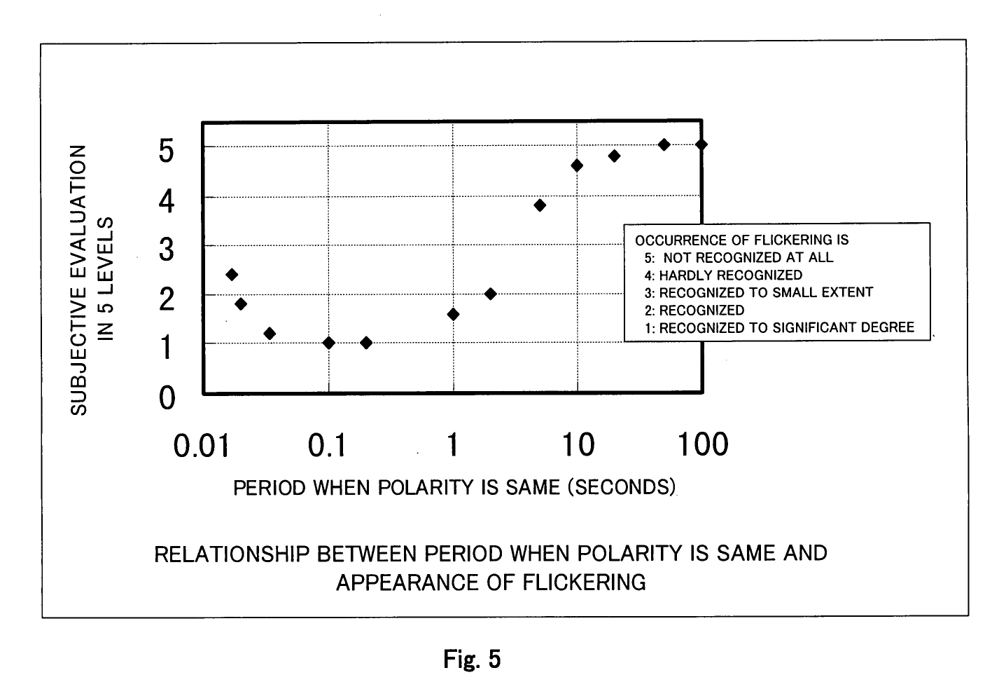

FIG. 5 shows a relationship between the polarity inversion period and how flickering is observed. This relationship is a result of a plurality of people evaluating, in 5 grades, a degree of appearance of flickering when the period of the polarity inversion is changed with a minimum unit (that is, no line inversion or dot inversion is executed) of one screen drive period (in the exemplified configuration, one field period) in a 2.5-inch LCD in which a low-temperature polycrystalline silicon TFT is used as a switching element and surface brightness is 150 cd/m². When the inversion period becomes longer than approximately 7 seconds, the evaluation is level 4 or 5, indicating that occurrence of the flickering is hardly recognized or is not recognized at all. In this manner, the inversion period is desirably increased in order to prevent occurrence of flickering, and it can be seen that the polarity period is preferably set to approximately 7 seconds or longer, more preferably approximately 10 seconds or longer. When the frame frequency is approximately 30 Hz, one frame period is approximately 0.03 seconds. Therefore, an inversion period of approximately 10 seconds is, in terms of number of frames, approximately 300 frames. When one frame is formed of two fields, one field period is half of 0.03 seconds, or 0.015 seconds. When, on the other hand, one frame is formed of n fields, n being an integer greater than or equal to three, the field period becomes a period corresponding to the number of fields (and the field periods may differ from each other).

As is clear from FIG. 5, occurrence of flickering is reduced when the polarity inversion period is increased. On the other hand, when the polarity inversion period is increased, a direct current voltage is applied to the liquid crystal for a longer period of time. Therefore, it is necessary to consider preventing problems such as generation of image burning and incapability of application of appropriate display voltage due to application of a residual DC to the liquid crystal, which is the original object of an alternating current inversion drive method. In order to maintain the display quality, the residual DC (Vdc) applied to the liquid crystal is desirably set so that the maximum application voltage Vpmax to be applied to the liquid crystal layer falls within a range which satisfies the following equation (1), when the voltage is applied with polarity inversion of a period T:
Vdc≦0.1×Vpmax (1)

When, in this manner, the residual DC component is less than or equal to 1/10 the maximum application voltage Vpmax, the influences on the display can be maintained at a low level that can be handled by, for example, the liquid crystal material and orientation film to be employed. In an LCD which is of a normally white mode and has a minimum value of transmittance, the maximum application voltage Vpmax corresponds to a black display level.

As the liquid crystal material, there is preferably used a material having high stability as a molecule and low ion reactivity; for example, a liquid crystal molecule having a fluoride group or a fluoride compound group at an end group of the liquid crystal. Use of a liquid crystal molecule having a low dielectric constant is also preferable. Because the ion reactivity is low, it is possible to prevent occurrence of image burning in which the liquid crystal molecule chemically reacts and the alignment is fixed, even when the application period of DC current is long. Because the dielectric constant is low, it is possible to increase a response speed of the liquid crystal with respect to a change of liquid crystal drive voltage, and, thus, to make it more difficult for a past applied voltage to affect the next display period.

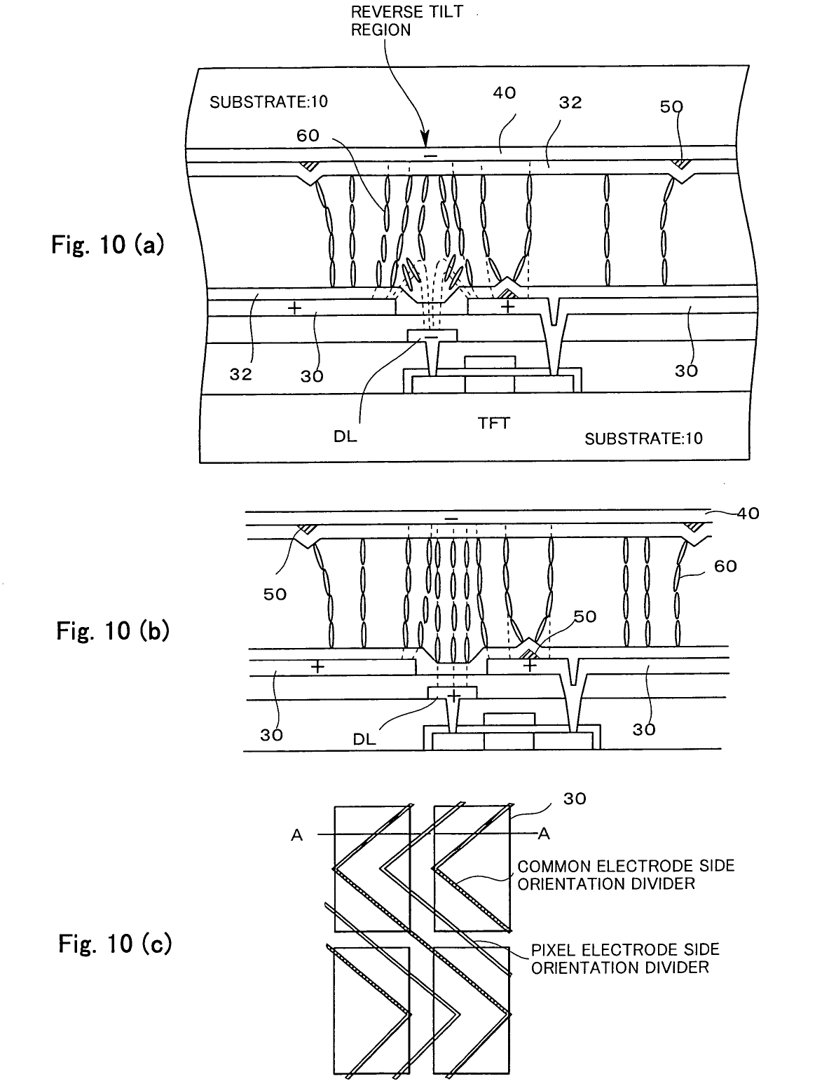

The thickness of the orientation film is preferably reduced. Orientation films are formed on one side, which is in contact with the liquid crystal layer, of each of two substrates to cover the pixel electrode and the common electrode, respectively. The orientation film is used to control the initial alignment of the liquid crystal (alignment of the liquid crystal when no voltage is applied) in a desired direction (regarding the position of formation, refer to the orientation film 32 of FIG. 10 to be described later). Normally, an insulating material such as polyimide is used for the orientation film 32. Therefore, when the thickness of the orientation film 32 is large, it becomes more difficult to apply voltages supplied to the pixel electrode and common electrode to the liquid crystal layer, which requires a longer time for setting the effective voltage applied to the liquid crystal layer to be a suitable voltage corresponding to the display content. Such a configuration makes it easier for the residual DC to be applied to the liquid crystal layer. For this purpose, for example, in the present embodiment, the orientation film 32 is formed to a very thin thickness of 20 nm˜30 nm, whereas a conventional orientation film normally has a thickness of 70 nm˜80 nm. With such as structure, the precision of application of voltage to the liquid crystal layer is improved and inhibition of occurrence of residual DC is enabled.

In addition, because the residual DC has a dependency on the material of the orientation film, the material of the orientation film must be at least a material having low occurrence of impurity ions, and preferably has low residual polarity.

As an example configuration, in the present embodiment, “SA5097,” a fluoride-based liquid crystal manufactured by Chisso Corporation, is used as the material of the liquid crystal, and occurrence of residual DC can be prevented when the polarity inversion period of the liquid crystal drive voltage is set to 10 seconds, by setting a chiral pitch of the liquid crystal layer to 40 μm, Δε to 5.5, and Δn to 0.129. “JALS1085,” manufactured by JSR Corporation, was used as the orientation film, which had a thickness of 20 nm.

The material of the liquid crystal layer and the orientation film are not limited to the above-described example configuration, and the objects of adjustment for reducing the residual DC component are not limited to the material of the liquid crystal and the orientation film. In any case, the residual DC component is desirably inhibited in a range described in the above-described equation (1).

The LCD employed in the present embodiment is a TN (Twisted Nematic) mode LCD which is commonly used. In the above description, a structure called “normally white mode” is such that white is displayed when no voltage is applied.

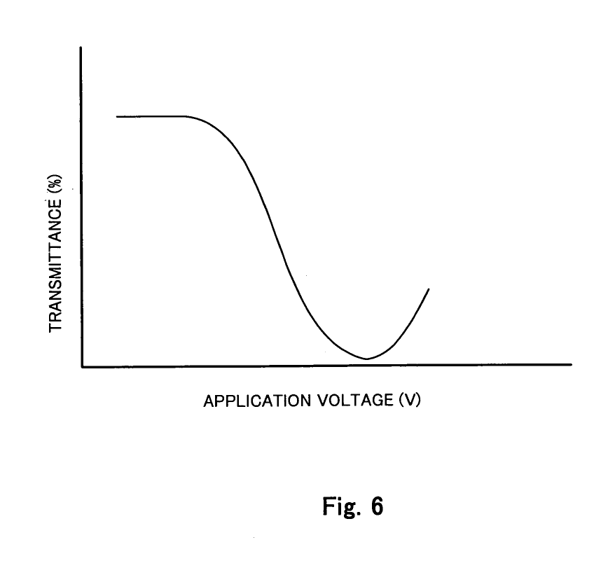

In the present embodiment, in addition to the TN mode, there can also be employed, for example, electrically controlled birefringence mode or ECB mode; that is, a method for controlling the transmittance of light entering the liquid crystal layer which uses a difference in index of refraction at the major and minor axes of the liquid crystal molecule; that is, which makes use of a birefringence phenomenon. Among various methods of the ECB mode, a type in which, for example, an initial alignment state of the liquid crystal is controlled to be approximately parallel (horizontal direction with respect to a plane of substrate) has a characteristic as shown in FIG. 6 in which a minimum value is present in the transmittance with respect to the application voltage. In addition, a structure of such a type is of a normally white mode in which white is displayed when no voltage is applied.

Examples of the liquid crystal having a minimum value of transmittance with respect to the application voltage as shown in FIG. 6 include, in addition to the ECB mode, an OCB mode (Optical Compensated Birefringence) and an STN (Super Twisted Nematic) mode depending on the twist angle.

In these LCDs (ECB, OCB, STN, etc.) having a minimum value of transmittance, when a voltage applied to the liquid crystal for minimizing transmittance deviates from an appropriate value, “black” can be displayed, and, thus, the display contrast is reduced. In the present embedment, occurrence of flickering is prevented by setting the polarity inversion period to be sufficiently longer than two frame periods. Therefore, in such an LCD having a minimum value of transmittance, flickering must be particularly considered and the LCD may be adjusted so that the voltage value showing the minimum value of transmittance is of equal absolute value in the positive polarity period and the negative polarity period. Thus, control of the LCD is easier and black can be reliably displayed, and, as a result, display with a high contrast can be achieved.

Of the normally white mode LCDs, in the TN mode LCD having no minimum value of transmittance with respect to the application voltage, black can be displayed by applying a sufficiently high voltage for black display even when the applied voltage exhibits a slight variation. On the other hand, when the polarity inversion is executed at a period of less than or equal to one frame period as in the conventional structure, flickering occurs. In order to minimize the noticeability of flickering, the polarity inversion must be adjusted so that the absolute value of a voltage indicating an intermediate gradation is applied to the liquid crystal layer in the positive polarity application period and in the negative polarity application period. On the other hand, the LCD having a minimum value of transmittance with respect to the application voltage is adjusted so that a voltage value indicating a minimum value of transmittance is of equal absolute value in the positive polarity period and in the negative polarity period as described above. In the present embodiment, there may also be employed a method in which the absolute value of a voltage value indicating a black level having a minimum transmittance is set equal in the positive polarity period and in the negative polarity period even in a TN mode and normally white mode LCD having no minimum value in the transmittance. With such a structure, black can be reliably displayed and contrast can be improved.

The adjustment to equate the voltage value showing a minimum value of transmittance is actually set in consideration of transmission characteristics of a positive polarity display data signal of the TFT provided between the data line and the pixel electrode and those of a negative polarity display data signal of the TFT and waveform rounding of a display data signal caused by, for example, ΔV shown in the above-described equation (2), and by an adjustor unit 149 adjusting a potential of a common electrode potential Vcom so that the black display voltage (absolute value of a potential difference between Vcom and Vp) applied to the liquid crystal becomes equal in the positive polarity period and in the negative polarity period. Because the transmission characteristics of the positive polarity signal and the negative polarity signal between a drain and a source cannot be set completely equal to each other in the currently developed TFT, difficulty is encountered in obtaining a completely symmetric waveform between the positive polarity period and the negative polarity period for the waveform of the display data signal. In the present embodiment, however, the adjustor unit 149 is provided for adjusting the common electrode potential Vcom. Therefore, the absolute value of the effective voltage applied to the liquid crystal layer can be easily set as close as possible in the positive polarity period and the negative polarity period.

Methods of inverting a polarity of applied voltage to the liquid crystal include a method in which the common electrode potential Vcom is set to a constant at all times and the polarity of the display voltage Vp is inverted, and a method in which the potential of the common electrode potential Vcom is changed when the polarity of the display voltage Vp is inverted.

In the above description, there is exemplified a configuration in which the potential of the common electrode potential Vcom is maintained constant as shown in FIG. 1.

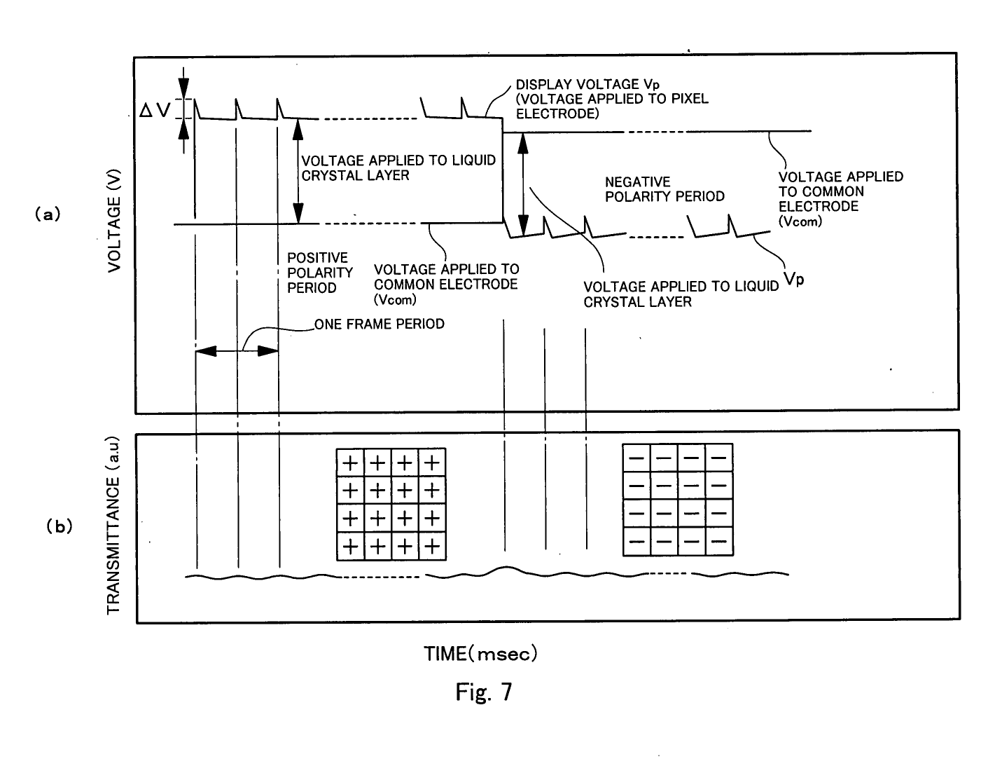

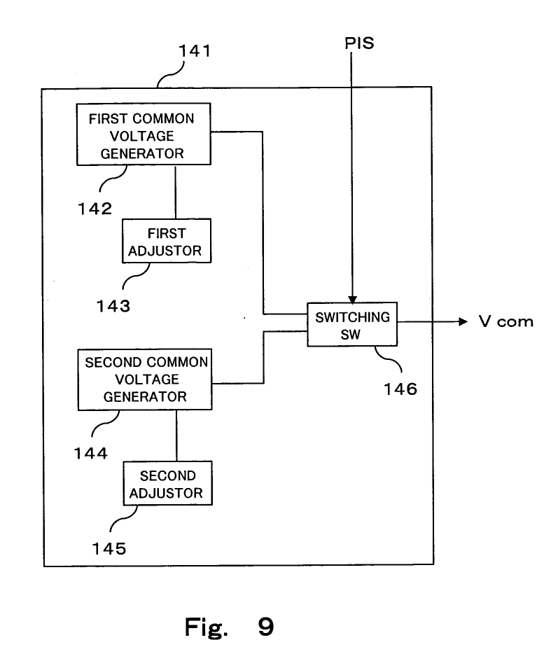

Alternatively, there may be employed a method of inverting the potential of the common electrode potential Vcom. FIG. 7 shows a waveform of a drive voltage applied to a liquid crystal layer of a target pixel and a change of transmittance of LCD in an active matrix LCD when the common electrode potential Vcom is inverted. When the potential of the common electrode potential Vcom is to be inverted, it is necessary, from the viewpoint of the common electrode side, to prepare at least two power supplies for Vcom and a circuit structure which switches an output potential of Vcom (refer to FIG. 9 to be described later). In addition, because the polarity is inverted, power consumption is increased as compared to a configuration in which the polarity is not inverted.

However, in the present embodiment, because the period of polarity inversion is very long, the increase in power consumption is small. From the viewpoint of the TFT, the polarity of the common electrode potential Vcom changes to a polarity opposite that of the display voltage Vp when the polarity of the display voltage Vp is inverted. Therefore, as shown in FIG. 7(a), even when the amplitude of the display voltage Vp is reduced, a voltage having a sufficient absolute value can be applied to the liquid crystal. As described, the display voltage Vp is a voltage which allows supply of a display data signal output to the data line DL to the pixel electrode 30 through the TFT 20 provided in each pixel. Therefore, when the amplitude of the display voltage Vp can be reduced, the amplitude of the AC voltage passing through the TFT 20 can be reduced, and a margin of the voltage resistance of the TFT 20 is increased, whereby load to the TFT 20 can be reduced.

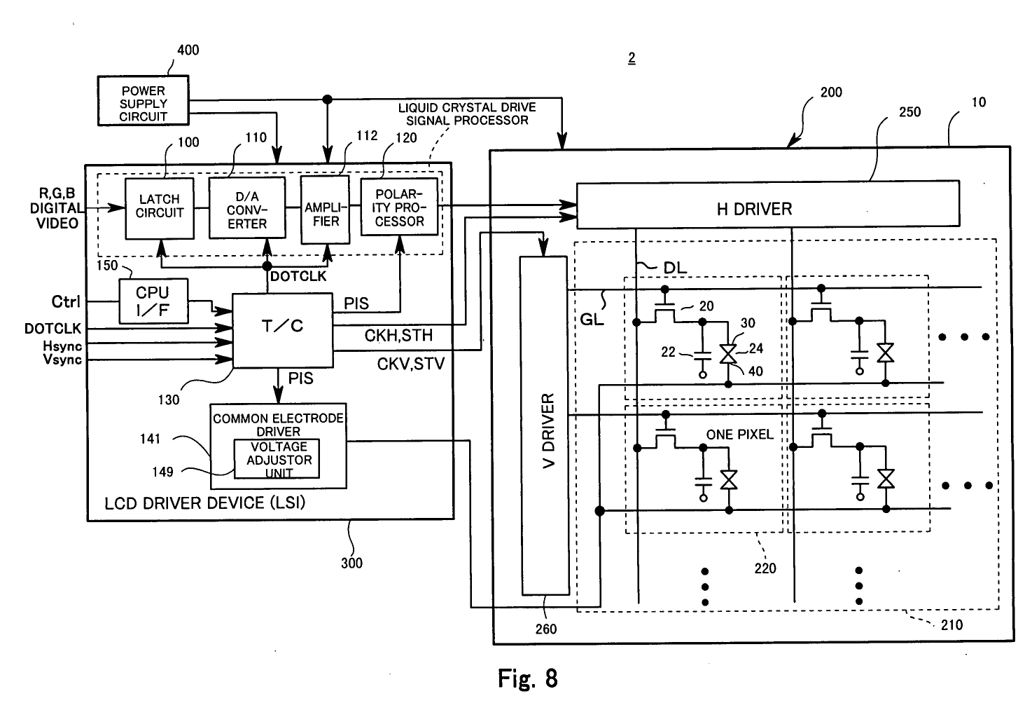

FIG. 8 schematically shows an example system structure of an LCD 2 which employs a drive method in which the potential of the common electrode potential Vcom as shown in FIG. 7 is also inverted. Elements identical to those in FIG. 2 are assigned the same reference numerals, and their repeated descriptions are omitted. A difference from the LCD shown in FIG. 2 lies that the polarity inversion control signal PS is also supplied to a common electrode driver 141.

FIG. 9 schematically shows a circuit structure of the common electrode driver 141 of FIG. 8. The common electrode driver 141 comprises a first common voltage generator 142, a second common voltage generator 144, first and second adjustors 143 and 145, and a switching switch (SW) 146. The first common voltage generator 142 generates a first common voltage of a positive polarity, and the second common voltage generator 144 outputs a second common voltage of a negative polarity to the switching SW 146.

Next, there will be described a configuration in which a VA mode, which is a type of ECB mode, is employed in the present embodiment. In the VA mode, the initial alignment of the liquid crystal is set to a vertical direction (direction normal to the substrate) and the transmittance does not have a minimum value. Such a VA mode LCD can obtain advantages similar to those yielded by the LCDs having the above-described modes. Of the VA mode LCDs, in a rubbing-less type LCD in which no rubbing process is applied to the orientation film, the polarity inversion is preferably employed at every plurality of frame periods rather than the 1H inversion or 1 dot inversion method, from the viewpoint of not only reduction of power consumption, but also improvement of display quality. FIGS. 10(a) and 10(b) schematically show cross sectional structures of such a rubbing-less type VA mode LCD, exemplifying a cross section along A-A line of an LCD having a schematic plane structure shown in FIG. 10(c). In this LCD, because the orientation film is of rubbing-less type, no pretilt is present in the initial alignment of the liquid crystal and the major axis direction of the liquid crystal molecule is oriented along a direction normal to the substrate when no voltage is applied. As shown in FIGS. 10(a) and 10(b), with the liquid crystal molecule 60 initially oriented along the vertical direction, when application of a voltage between a common electrode 40 and a pixel electrode 30 of the LCD is started, a weak electric field which is generated at an initial state of low voltage (refer to electric lines of force shown by dotted lines in FIGS. 10(a) and 10(b)) is tilted at an angle at an end or the like of the pixel electrode 30, and the tilted electric field defines a direction along which the liquid crystal molecules are tilted in response to an increase in the voltage.

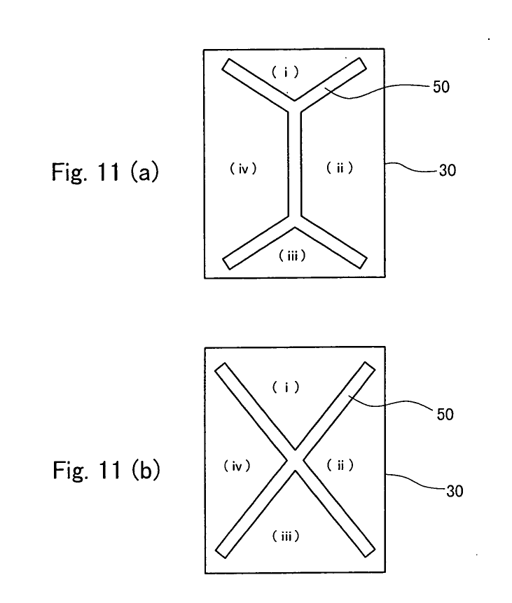

A pixel region can be divided by, for example, an orientation divider 50 as shown in the figures so that the pixel region can be divided into a plurality of regions of difference directions. In other words, as shown with (i)-(iv) in FIG. 11 which will be described later, one pixel region can be divided into a plurality of regions having different priority viewing directions and the range of viewing angle can be increased for each pixel; that is, for the display.

In the exemplified configuration shown in FIGS. 10(a) and 10(b), the orientation divider 50 can be formed by an electrode-absent region (window) or by providing a projection on an electrode, and is formed in a bent line pattern along a vertical direction of the figure, on both the common electrode 40 and the pixel electrode 30. The orientation divider 50 is not limited to such a pattern, and can be formed by providing an electrode-absent region (window) and a projection, for example, in a pattern in which an upper end and a lower end along a longitudinal direction are each separated into two branches in one pixel region as shown in FIG. 11(a), or in a pattern (X-shaped pattern) in which the orientation dividers 50 intersect each other at the center of one pixel as shown in FIG. 11(b). With such an orientation divider 50, as shown in FIGS. 10(a) and 10(b), the boundary of alignment directions of the liquid crystal within one pixel can be fixed on the divider 50 so that adverse effects to display quality are prevented, such as presence of a rough surface due to difference in the boundary position of the directions to which the liquid crystal molecules are tilted among pixels or among the drive timings.

In the VA mode LCD as described above, the liquid crystal molecule 60 tends to be affected not only by the pixel electrode 30, but also by an electric field generated by structures formed below the pixel electrode 30, such as a gate line GL for driving the TFT and a data line DL for supplying a display data signal to the pixel electrode 30 through the TFT. In particular, for example, when the polarity of an application voltage to the liquid crystal is inverted every 1H, regarding one data line DL, the polarity of the display data signal supplied to the data line DL is inverted every 1H period, and, thus, a display data signal of negative polarity is applied, for example, to a data line DL which is present between pixel electrodes 30 to which a voltage of positive polarity is applied as shown in FIG. 10(a). In the next 1H period, the polarity of the display data signal on the data line DL is again inverted.

Therefore, there is a possibility that, as shown in FIG. 10(a), the electric field leaking from the data line DL to the liquid crystal layer may disturb the sloped electric field at the end of the pixel electrode 30. As described, the sloped electric field at the end of the pixel electrode 30 is an important electric field which defines the alignment direction of the liquid crystal within a pixel region. When the position of the sloped electric field is shifted by a leaking electric field from the data line DL or the like, a boundary of alignment directions occur at an unintended position in a pixel region; that is, a reverse tilt region is generated and the display quality may be deteriorated. In the present embodiment, however, because occurrence of flickering is prevented by setting the polarity inversion period to correspond to a plurality of frame periods, there is no need to employ the 1H inversion method or 1 dot inversion method, and, thus, the chance that the polarity on the data line DL (display data signal) within a screen becomes opposite the polarity of the voltage applied to the pixel electrode 30 becomes very small. Therefore, it is possible to prevent not only the flickering phenomenon, but also a reverse tilt phenomenon as depicted in FIG. 10(b). Therefore, it is possible to realize an LCD having very high display quality and low power consumption. In the above, occurrence of a reverse tilt and inhibition of the reverse tilt in a VA mode LCD have been described. Occurrence of reverse tilt can be inhibited in a similar manner by employing the polarity inversion period of the present embodiment in the TN mode, ECB mode, etc.

The present embodiment can be applied to a transmissive LCD in which display is achieved by light from a light source placed behind the panel or the like, and a transparent conductive electrode such as ITO is used in both the pixel electrode and the common electrode; a reflective LCD in which a reflective metal electrode is used as the pixel electrode and light from the outside is reflected to realize display; and a transflective LCD which functions in a transmissive mode when a light source is used and in a reflective mode when the light source is switched off. The reflective LCD and transflective LCD require a further improvement in contrast or the like, and display with a sufficiently high contrast can be achieved in, for example, a reflective LCD or transflective LCD in ECB mode through polarity inversion as described in the present embodiment.

### INDUSTRIAL APPLICABILITY

The present invention can be applied to liquid crystal display devices provided in various electronic devices.

1. A method of driving a liquid crystal display device in which two substrates having respective electrodes for driving liquid crystal on opposing surfaces are provided opposing each other with a liquid crystal layer therebetween and comprising a plurality of pixels, the method comprising:
applying a liquid crystal drive voltage to the liquid crystal layer in each pixel; and
maintaining the liquid crystal drive voltage at a same polarity with respect to a predetermined reference for a period of two frame periods or longer.

2. A method of driving a liquid crystal display device according to claim 1, wherein
the liquid crystal drive voltage is maintained at the same polarity for a period of 10 seconds or longer.

3. A method of driving a liquid crystal display device according to claim 1, wherein
a polarity of the liquid crystal drive voltage is inverted with a minimum unit of a screen drive period which corresponds to a drive period of all pixels of the plurality of pixels.

4. A method of driving a liquid crystal display device according to claim 1, wherein
a period t over which the liquid crystal drive voltage is applied at a same polarity is set to a period which is shorter than or equal to a period in which a relationship between a maximum application voltage Vpmax which is applied to the liquid crystal layer and a residual direct current voltage Vdc generated in the liquid crystal layer when the maximum application voltage Vpmax is applied to the liquid crystal layer at a same polarity for the period t satisfies the following equation (1):
Vdc≦0.1*Vpmax (1)

5. A method of driving a liquid crystal display device according to claim 1, wherein
application times of the liquid crystal drive voltage for a positive polarity which is applied to the liquid crystal layer and the liquid crystal drive voltage of a negative polarity which is applied to the liquid crystal layer are set equal to each other.

6. A method of driving a liquid crystal display device according to claim 1, wherein
the liquid crystal display device has a characteristic such that a transmittance with respect to an application voltage has a minimum value, and
an electrode potential of the opposing substrate is set such that an absolute value of a potential difference becomes equal in a period in which a polarity of a liquid crystal drive potential applied to the liquid crystal layer with respect to the electrode potential of the opposing substrate is a positive polarity and in a period in which the polarity of the liquid crystal drive potential applied to the liquid crystal layer with respect to the electrode potential of the opposing substrate is a negative polarity in a black display.

7. A method of driving a liquid crystal display device according to claim 6, wherein
the liquid crystal display device operates in an electrically controlled birefringence mode.

8. A method of driving a liquid crystal display device according to claim 1, wherein
a polarity of a voltage applied to a pixel electrode formed individually for each of the plurality of pixels with respect to a predetermined reference is inverted at the period of two frame periods or longer and a voltage applied to a common electrode which opposes the pixel electrode with the liquid crystal layer therebetween is set to a constant, so that a polarity of a liquid crystal drive voltage applied to the liquid crystal layer with respect to a predetermined reference is inverted at the period of two frame periods or longer.

9. A method of driving a liquid crystal display device according to claim 1, wherein
a polarity of a voltage applied to a pixel electrode formed individually for each of the plurality of pixels with respect to a predetermined reference is inverted at the period of two frame periods or longer, and
a polarity of a voltage applied to a common electrode which opposes the pixel electrode with the liquid crystal layer therebetween is inverted in synchronization with the inversion of the polarity of the voltage applied to the pixel electrode.

10. A liquid crystal display device in which two substrates having respective electrodes for driving liquid crystal on opposing surfaces are provided opposing each other with a liquid crystal layer therebetween and comprising a plurality of pixels, the liquid crystal display device comprising:
a liquid crystal drive signal processor which generates a liquid crystal drive voltage to be applied to the liquid crystal layer on the basis of an image signal; and
a predetermined period determination unit which determines elapse of a predetermined period which is two frame periods or longer and outputs a polarity inversion control signal for inverting a polarity of the liquid crystal drive voltage, wherein
the liquid crystal drive signal processor inverts the polarity of the liquid crystal drive voltage according to the polarity inversion control signal, and
a polarity of the liquid crystal drive voltage applied to the liquid crystal layer with respect to a predetermined reference is maintained at a same polarity in each pixel for a period of two frame periods or longer.

11. A liquid crystal display device according to claim 10, wherein
the predetermined period determination unit determines elapse of a period of 10 seconds or longer, and
the liquid crystal drive signal processor maintains the liquid crystal drive voltage at the same polarity for a period of 10 seconds or longer.

12. A liquid crystal display device according to claim 10, wherein
a period t determined by the predetermined period determination unit is set to be shorter than or equal to a period in which a relationship between a maximum application voltage Vpmax to be applied to the liquid crystal layer and a residual direct current voltage Vdc generated in the liquid crystal layer when the maximum application voltage Vpmax is applied to the liquid crystal layer at the same polarity for the period t satisfies the following equation (1):
Vdc≦0.1*Vpmax (1)

13. A liquid crystal display device according to claim 10, wherein
a period determined by the predetermined period determination unit is set to a period so that application times of the liquid crystal drive voltage of a positive polarity applied to the liquid crystal layer and of the liquid crystal drive voltage of a negative polarity applied to the liquid crystal layer are equal to each other.

14. A liquid crystal display device according to claim 10, further comprising:
a setter unit which arbitrarily sets the determination period in the predetermined period determination unit.

15. A liquid crystal display device according to claim 10, wherein
the liquid crystal display device has a characteristic in which transmittance with respect to an application voltage to the liquid crystal layer has a minimum value,
the liquid crystal display device further comprises an opposing electrode driver which drives an electrode on an opposing substrate, and
the opposing electrode driver sets an electrode potential of the opposing substrate so that an absolute value of a potential difference is equal during a period in which a polarity of a liquid crystal drive potential applied to the liquid crystal layer with respect to the electrode potential of the opposing substrate is a positive polarity and in a period in which the polarity of the liquid crystal drive potential applied to the liquid crystal layer with respect to the electrode potential of the opposing substrate is a negative polarity during black display.

16. A liquid crystal display device according to claim 15, further comprising:
an adjustor unit which adjusts the electrode potential of the opposing electrode which is set by the opposing electrode driver.

17. A liquid crystal display device according to claim 16, wherein
the liquid crystal display device operates in an electrically controlled birefringence mode.

18. A liquid crystal display device according to claim 10, further comprising:
an opposing electrode driver which drives an electrode on the opposing substrate, wherein
the opposing electrode driver comprises an opposing electrode drive voltage inverting unit which inverts a polarity of an electrode potential applied to the opposing substrate in synchronization with the inversion of polarity of the liquid crystal drive potential applied to the liquid crystal layer.

19. A driver device of a liquid crystal display panel in which two substrates having respective electrodes for driving liquid crystal on opposing surfaces are provided opposing each other with a liquid crystal layer therebetween and comprising a plurality of pixels, the driver device comprising:
a liquid crystal drive signal processor which generates a liquid crystal drive voltage to be applied to the liquid crystal layer on the basis of an image signal, and
a predetermined period determination unit which determines elapse of a predetermined period which is two frame periods or longer and outputs a polarity inversion control signal for inverting a polarity of the liquid crystal drive voltage, wherein
the liquid crystal drive signal processor comprises a polarity processor which inverts the polarity of the liquid crystal drive voltage on the basis of the polarity inversion control signal, and
the liquid crystal drive voltage applied to the liquid crystal layer in each pixel is maintained at the same polarity with respect to a predetermined reference over a period of two frame periods or longer.

20. A driver device of a liquid crystal display panel according to claim 19, wherein
the predetermined period determination unit determines elapse of a period of 10 seconds or longer, and
the liquid crystal drive signal processor maintains the liquid crystal drive voltage at the same polarity for a period of 10 seconds or longer.

21. A driver device of a liquid crystal display panel according to claim 19, further comprising:
a timing controller which generates a timing signal for controlling an operation timing at the liquid crystal display panel on the basis of a synchronization signal and a predetermined clock signal supplied with the image signal, wherein
the timing controller also functions as the predetermined period determination unit, determines elapse of a predetermined period on the basis of the synchronization signal, and generates the inversion control signal.
